(19) United States
(12) Patent Application Publication
(10) Pub. No.: US 2007/0266099 A1
(43) Pub. Date: Nov. 15, 2007

(54) Method and wireless communication apparatus for transmitting and receiving contact information

(76) Inventors: Jyh-Chun Wang, Taipei City (TW); Guan-Hua Tu, Taipei City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/390,717

(22) Filed: Mar. 28, 2006

(51) Int. Cl. G06F 15/16

(52) U.S. Cl. 709/206

(57) ABSTRACT

A method and a mobile unit for transmitting and for receiving contact information are provided. A memory for transmission stores a profile datum and a multimedia datum of the contact information. An encoder retrieves the profile datum and the multimedia datum from the memory, encodes the profile datum in a first format into a first file, and encodes the multimedia datum in a second format into a second file. A transmission unit transmits both of the first file and the second file. A receiving unit receives a first file and a second file. A processor determines whether the first file and the second file comprise the profile datum and the multimedia datum, and generates a signal if yes. A decoder decodes the profile datum in the first format and decodes the multimedia datum in the second format in response to the signal. A memory for receiving stores the decoded profile datum in a first location based on the first format and the decoded multimedia datum in a second location based on the second format.

### BACKGROUND OF THE INVENTION

1. Field of the Invention

The present invention relates to methods and wireless communication apparatuses for transmitting and for receiving contact information; more particularly, relates to methods and wireless communication apparatuses for transmitting and receiving a profile datum and a multimedia datum of the contact information without converting the original formats of the data.

2. Descriptions of the Related Art

People record persons' profiles in an electronic phonebook to collect their contact information. FIG. 1A shows one example of an electronic phonebook. The electronic phonebook 1 comprises text profile data, such as a name 101, an employee number 103, a home phone number 105, a company phone number 107, an office phone number 109, a fax number 111, an e-mail address 113, a birthday 115, a nick name 117, an home address 119, a personal homepage 121, a job title 123, a note 125, etc. Some of the electronic phonebooks may further include customized multimedia information, e.g., a photo 127, a sound 129 and a video 131, as FIG. 1A shows.

The concept of such an electronic phonebook is now applied to wireless communication devices. For mobile phones, a vCard (electronic business card) is one type of the electronic phonebooks. With the progress of wireless communication technology, the profile data of the vCard can be transmitted between mobile phones. In the vCard, some standard fields are currently defined for compatibility of data transferring between two different mobile phones. While transmitting the vCard, the profile data in the standard fields will be together encoded into a VCF file. The receiving mobile phone will receive and decode the VCF file back into original profile data. To decode the received VCF file, the receiving mobile phone will parse the standard fields of the VCF file to derive the original profile data. Generally, the standard fields of the vCards for mobile phones include: identification types, delivery addressing types, telecommunications addressing types, geographical types, organization types, explanatory types, security types, extended types, etc. The identification type may include name, photograph, and birth date information. The explanatory type may include sound and URL information. The extended type is for non-standard information.

In addition to exchanging text information, more and more people like to include multimedia files in their profile, such as a personal ring tone, a picture, or a video. These files however cannot be properly received by most of the current mobile phones due to two reasons.

One is, even though the identification type and the explanatory type to include photograph and sound files, they however only support limited file formats. For example, for photograph files, they support only GIF, TIFF, MPEG, AVI, BMP, and so on. Any files with other formats cannot be correctly parsed and decoded by the receiving mobile phones.

One solution to overcome the inconvenience is to add undefined file formats of multimedia data in the extended types, so that mobile phones can recognize the multimedia data. One defect of this solution is that both the transmitting mobile phone and the receiving mobile phone must add the undefined file formats in the extended types in advance, since it is not standardized. It apparently lacks compatibility.

The other problem is that the size of the multimedia data might be huge with comparison to text profile data. Since all data will be encoded into one VCF file for transmission, if the size of the multimedia data is huge, it is difficult to transmit by current communication systems. Sometimes, it might take a long time waiting for receiving the vCard. It is very troublesome and inconvenient to users. Thus, in reality, the multimedia data of a huge size will be ignored and it won't be transmitted along with the profile data.

FIG. 1B shows an example of the conventional method of transmitting a vCard between mobile units. As shown in FIG. 1B, while transmitting the vCard 11 having both a profile datum 13 and a multimedia datum 12 from a mobile unit 10 to a mobile unit 20, the mobile unit 10 will first check whether the size of the multimedia datum 12 exceeds a predetermined upper limit and whether the format of the multimedia datum 12 is supported by the mobile units 10 and 20. If the size exceeds the predetermined upper limit or the format is not supported by the mobile units 10 and 20, the mobile unit 10 would ignore the multimedia datum 12 and encode only the profile datum 13 into a VCF file 14 for transmission. The VCF file 14 will be transmitted via a communication network 30 to the mobile unit 20. While receiving the VCF file 14, the mobile unit 20 can parse and decode the VCF file 14 back into the original profile datum 13. In the conventional approach, due to the size or the format of the multimedia datum 12, the mobile unit 20 can not get the multimedia datum 12 of the vCard.

Therefore, a solution to transmit the profile data and the customized multimedia information is desired.

### SUMMARY OF THE INVENTION

One object of this invention is to provide a method for transmitting contact information. The contact information comprises a profile datum and a multimedia datum. The method comprises the step of: encoding the profile datum in a first format into a first file; encoding the multimedia datum in its multimedia format into a second file, a third file, etc.; and transmitting both the first file and the other multimedia files.

Another object of this invention is to provide a method for receiving contact information. The contact information comprises a profile datum and a multimedia datum. The method comprises the steps of: receiving a first file and a second file; determining whether the first file and the second file comprise the profile datum and the multimedia datum, if yes, executing the following steps; decoding the profile datum in a first format; storing the decoded profile datum to a first location based on the first format; decoding the multimedia datum in a second format; and storing the decoded multimedia datum to a second location based on the second format and so on.

Another object of this invention is to provide a mobile unit for transmitting contact information. The contact information comprises a profile datum and a multimedia datum. The mobile unit comprises a memory, an encoder, and a transmission unit. The memory is configured to store the profile datum and the multimedia datum. The encoder is configured to retrieve the profile datum and the multimedia datum from the memory, to encode the profile datum in a first format into a first file, and to encode the multimedia datum in a second format into a second file. The transmission unit is configured to transmit both of the first file and the second file.

Yet a further object of this invention is to provide a mobile unit for receiving contact information. The contact information comprises a profile datum and a multimedia datum. The mobile unit comprises a receiving unit, a processor, a decoder, and a memory. The receiving unit is configured to receive a first file and a second file. The processor is configured to determine whether the first file and the second file comprise the profile datum and the multimedia datum, and to generate a signal if yes. The decoder is configured to decode the profile datum in a first format and to decode the multimedia datum in a second format in response to the signal. The memory is configured to store the decoded profile datum in a first location based on the first format and the decoded multimedia datum in a second location based on the second format.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A shows a schematic of an electronic phonebook;

FIG. 1B shows a conventional method of transmission a vCard between mobile units;

FIG. 2A shows a flow chart of a method for transmitting a vCard in accordance with the present invention;

FIG. 2B shows an embodiment of transmission contact information between mobile units in accordance with the present invention;

FIG. 3 shows a flow chart of setting links automatically in accordance with the present invention;

FIG. 4 shows a flow chart of setting links manually in accordance with the present invention;

FIG. 5 shows a schematic of a mobile unit for transmitting a vCard in accordance with the present invention;

FIG. 6 shows a flow chart of a method for receiving a vCard in accordance with the present invention;

FIG. 7 shows a schematic of a mobile unit for receiving a vCard in accordance with the present invention; and

FIG. 8 shows a schematic of an option menu in accordance with the present invention.

### DESCRIPTION OF THE PREFERRED EMBODIMENT

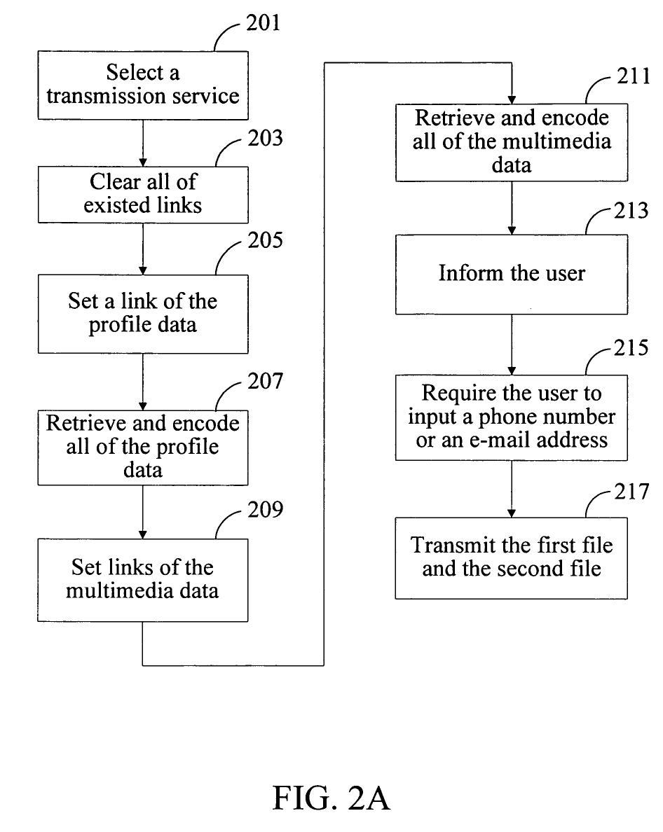

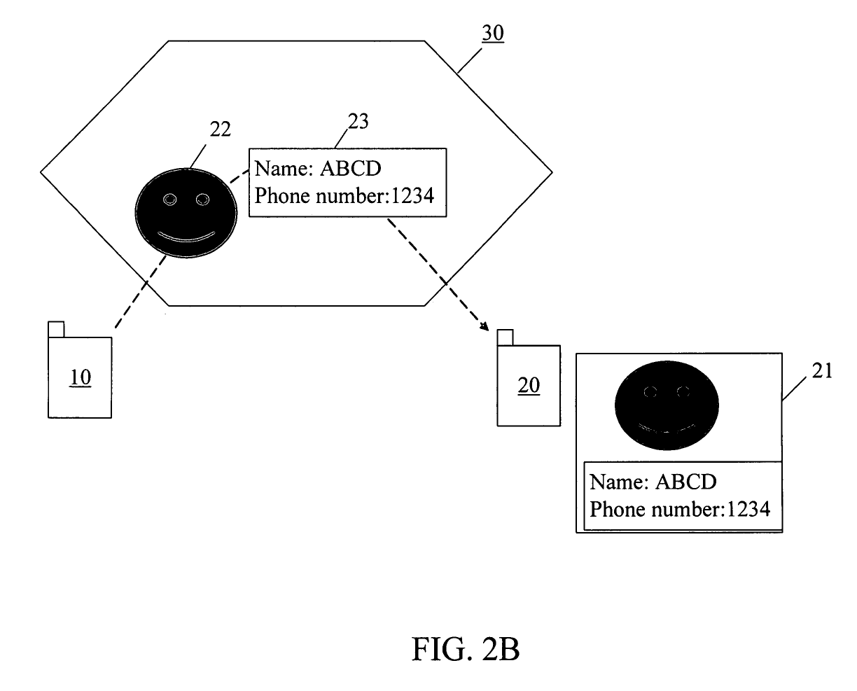

FIG. 2A and FIG. 2B show a first embodiment of the present invention for transmitting contact information. As shown in FIG. 2B, the contact information 21 comprises several profile data 23 and multimedia data 22, wherein the contact information 21 can be in a vCard format or the like. In the following illustration, the profile data 23 is text data and the multimedia data 22 is an image file. However, it is only an example, rather than a limitation to the present invention. In some embodiments, the multimedia data 22 may further include image files, audio files and video files. Each type of multimedia data can be encoded into an individual file for transmission. For example, if the multimedia data 22 contains a caller picture and a caller ring tone, the mobile unit may encode them separately into an image file and an audio file. The quantity and type of those multimedia files are not limited in the present invention.

As shown in FIG. 2B, while transmitting contact information 21 having both the profile data 23 and the multimedia data 22 from a mobile unit 10 to a mobile unit 20, the mobile unit 10 would encode the profile data 23 and the multimedia data 22 into at least two files and separately transmit them to the mobile unit 20 via a communication network 30. For example, rather than encoding all contents in the contact information 21 into one file, as shown in FIG. 2B, the mobile unit 10 separately encodes the profile data 23 into a VCF file and the multimedia data 22 into a BMP file for transmission. Users may choose to transmit the VCF file and the BMP file via the same communication network 30 or via different communication networks. While receiving those two files, the mobile unit 20 will decode them back into the original data, the profile data 23 and the multimedia data 22. Users may choose to store them together or in different file folders. To allow users to view the profile data 23 and the multimedia data 22 integratedly, the file folders may be further linked together, so that the stored profile data 23 and the stored multimedia data 22 can be displayed at the same time. However, it should be noted that the received contact information can be arranged in different way based on user demands, which is not a limitation in the present invention. The mobile units 10 and 20 of the first embodiment may be a mobile phone, a PDA (Personal Digital Assistant), a portable computer with wireless networking capability, or the like. The communication network 30 can be GSM, GPRS, EDGE, WiFi or WCDMA communication systems. The mobile unit at least comprises a processor, a memory, an encoder, a transmission unit, and a display screen. It should be noted that the method of the present invention can be operated when the mobile units are in communication with other devices, for example, while doing a video conference, if the communication system allows.

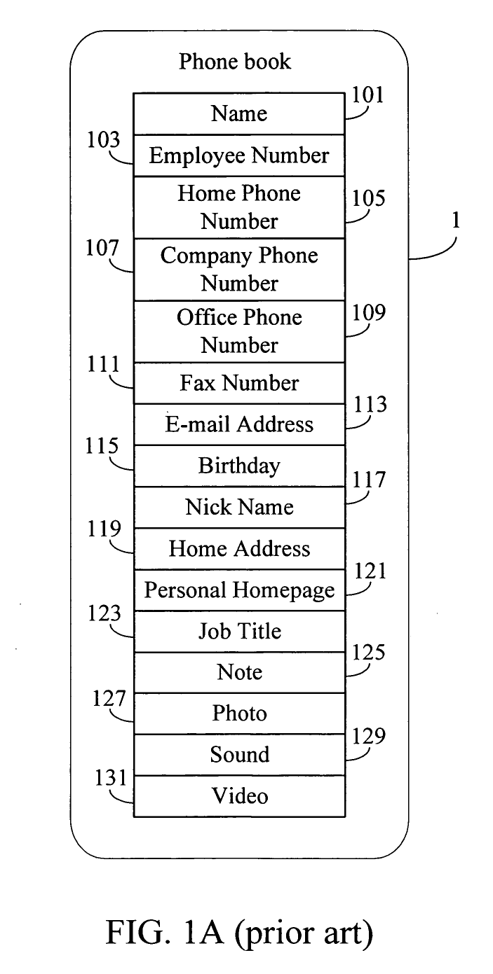

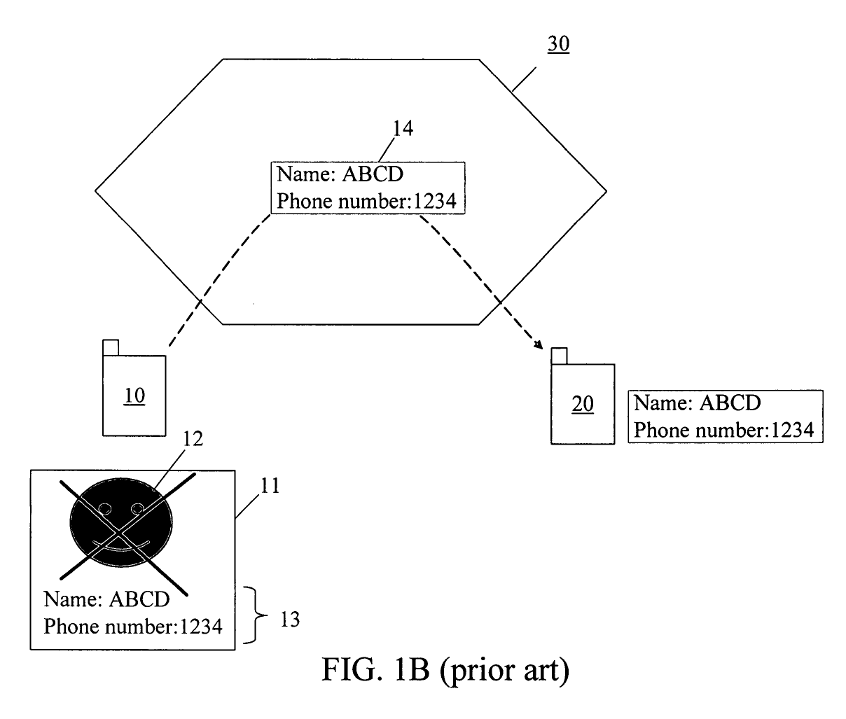

Compared to the conventional approach illustrated in FIG. 1B, the present invention can transmit all kinds of contact information without considering the types and sizes of the multimedia data thereof.

FIG. 2A further illustrates the method for transmitting contact information in accordance with the present invention. When transmitting the contact information, step 201 is first executed in which the processor selects a transmission service in response to a user's instruction. The transmission service may be multimedia messaging service (MMS), electronic mail (e-mail), infrared data association (IrDA), WiFi, or Bluetooth. It should be noted that step 201 is only an optional step that can be skipped in some situations. For example, it may be automatically selected by the processor or it may just stick to one predetermined transmission service without allowing users to select other transmission services. Furthermore, in wideband communication system, such as GPRS, EDGE, or WCDMA, it may not need to choose a transmission service, since all data can be transmitted directly via communication channels.

Then, step 203 is executed in which the processor clears all of previous links to avoid the existed links influencing the current transmission, and step 205 is executed to build a new link of the profile data. The new link points to a particular location of the memory where the profile data are stored.

Then step 207 is executed in which the encoder retrieves and encodes all of the profile data of the contact information from the memory in a first format into a first file which is going to be transmitted through the selected transmission service. In this embodiment, the first format is the original vCard format, i.e., a VCF format.

After the profile data is encoded, step 209 is executed to further build the links of the multimedia data of the contact information. The links point to particular locations of the memory where the multimedia data are stored. Then step 211 is executed in which the encoder retrieves and encodes all of the multimedia data from the memory in a second format into at least a second file which is also transmitted through the selected transmission service. The second format may be any format of an image file, a video file and an audio file, such as GIF, CGM, WMF, BMP, MET, PMB, DIB, PICT, TIFF, PS, PDF, JPEG, MPEG, MPEG2, AVI, QTIME, WAVE, PCM, AIFF, 3GP, JPG, WMA, or MP3, etc. format. In some embodiments, the multimedia data may be encoded into more than one file. For example, when the multimedia data contains a caller picture and a caller ring tone, the present invention will encode them into an image file, such as a GIF file, and an audio file, such as a MP3 file. For brevity, in this embodiment, it is assumed that only one multimedia file is encoded, which is however not a limitation to the present invention.

After the multimedia data is encoded, step 213 is executed in which the display screen shows a message to inform the user that the first file and the second file are completely prepared. Step 215 is then executed wherein the display screen shows another message to require the user to input a phone number or an e-mail address for transmission. After the user inputs a phone number or an e-mail address, step 217 is executed wherein the transmission unit transmits the first file and the second file through the selected transmission service. It should be noted that steps 213 to steps 215 can be altered or skipped based on different user interface design.

Alternatively, the profile data and the multimedia data may be retrieved after the links of the profile data and the multimedia data are all set. That is, step 207 and step 211 can be executed posterior to step 205 and step 209. Moreover, the sequence of the aforementioned steps is for the purpose of an example. The sequence is not intended to be a limitation of the present invention.

In the embodiment, the user may decide transmitting the multimedia data automatically or manually. When the processor finds that there is at least one multimedia datum associated with the contact information, the display screen displays a query. The query includes, for example, an option of transmitting all of the multimedia data automatically, an option of transmitting each of the multimedia data manually, and an option of no transmission for all of the multimedia data.

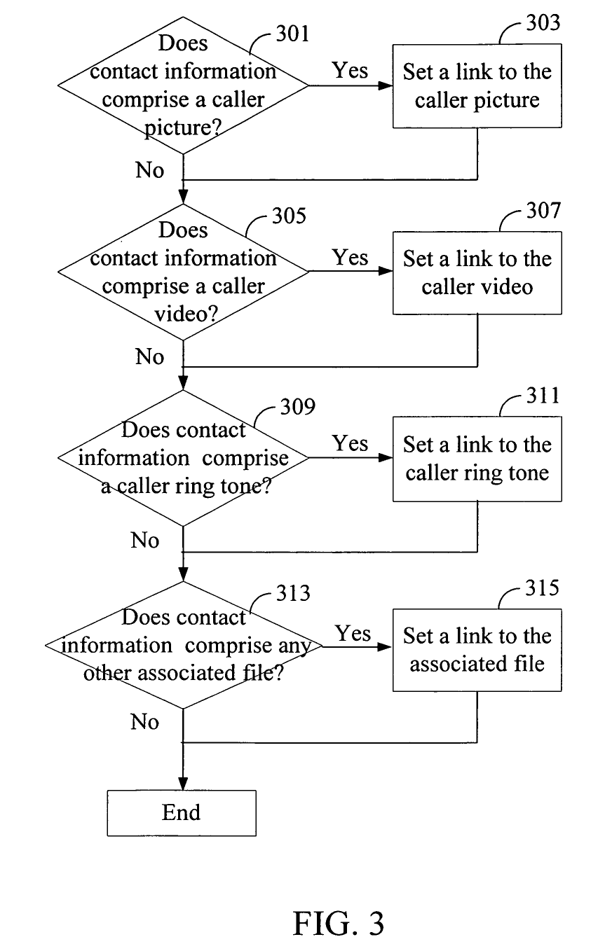

FIG. 3 shows further steps of step 209 when the selected transmission service is MMS or email and the user selects the option of transmitting all of the multimedia data automatically. In step 301, the encoder determines if the contact information comprises a caller picture. If yes, step 303 is executed wherein a link, i.e., a file path to the caller picture is set. If no or step 303 is executed, step 305 is then executed wherein the encoder determines if the contact information comprises a caller video. If yes, step 307 is executed wherein a link, i.e., a file path to the caller video is set. If no or step 307 is executed, step 309 is then executed wherein the encoder determines if the contact information comprises a caller ring tone. If yes, step 311 is then executed wherein a link, i.e., a file path to the caller ring tone is set. If no or step 311 is executed, step 313 is then executed wherein the encoder determines if the contact information comprises any other associated file. If yes, step 315 is then executed wherein a link, i.e., a file path to the associated file is set. If no or step 315 is executed, step 209 is complete. Similarly, the sequence of steps 301, 303, . . . , 315 is not intended to be a limitation of the present invention.

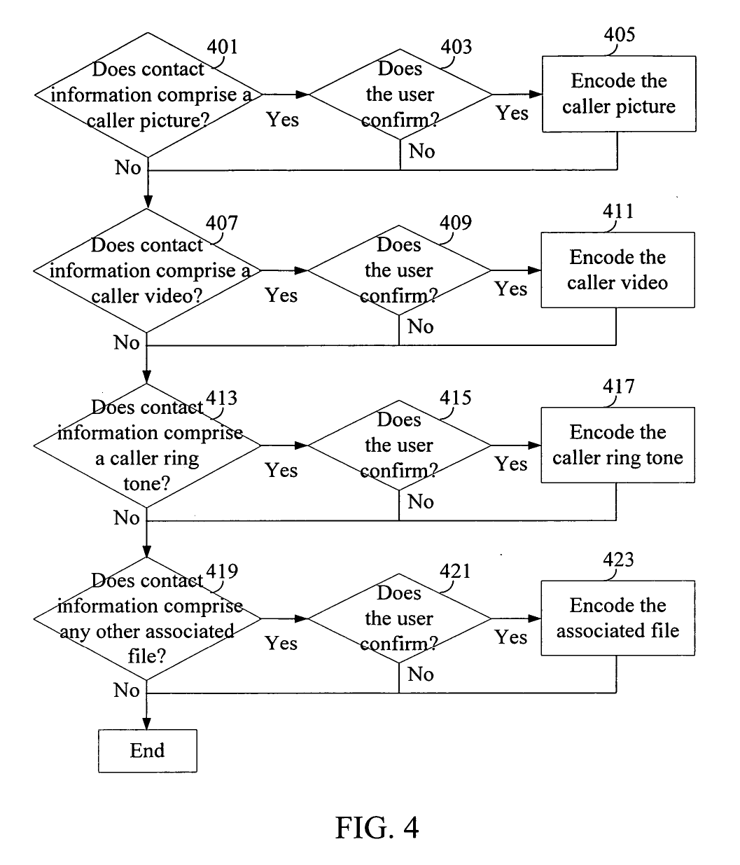

FIG. 4 shows further steps of step 209 when the selected transmission service is IrDA or Bluetooth and the user selects the option of transmitting each of the multimedia data manually. In step 401, the encoder determines if the contact information comprises a caller picture. If yes, step 403 is executed in which the display screen displays a query for confirmation of transmitting the caller picture. If confirmed by the user, step 405 is executed in which the encoder encodes the caller picture for transmission. In some embodiments, when the encoder determines the contact information comprises a caller picture in step 401, the step 403 and step 405 can be skipped to allow the caller picture to be directly transmitted.

In this embodiment, if no in step 401, no in step 403, or step 405 is executed, step 407 is then executed in which the encoder determines if the contact information comprises a caller video. If yes, step 409 is executed in which the display screen displays a query for confirmation of transmitting the caller video. If confirmed by the user, step 411 is executed in which the encoder encodes the caller video for transmission. If no in step 407, no in step 409, or step 411 is executed, step 413 is then executed in which the encoder determines if the contact information comprises a caller ring tone. If yes, step 415 is executed in which the display screen displays a query for confirmation of transmitting the caller ring tone. If confirmed by the user, step 417 is executed in which the encoder encodes the caller ring tone for transmission. If no in step 413, no in step 415, or step 417 is executed, step 419 is then executed in which the encoder determines if the contact information comprises any other associated file. If yes, step 421 is executed in which the display screen displays a query for confirmation of transmitting the associated file. If confirmed by the user, step 423 is executed in which the encoder encodes the associated file for transmission. If no in step 419, no in step 421, or step 423 is executed, step 209 is finished. Similarly, the sequence of steps 401, 403, . . . , 423 is not intended to be a limitation of the present invention.

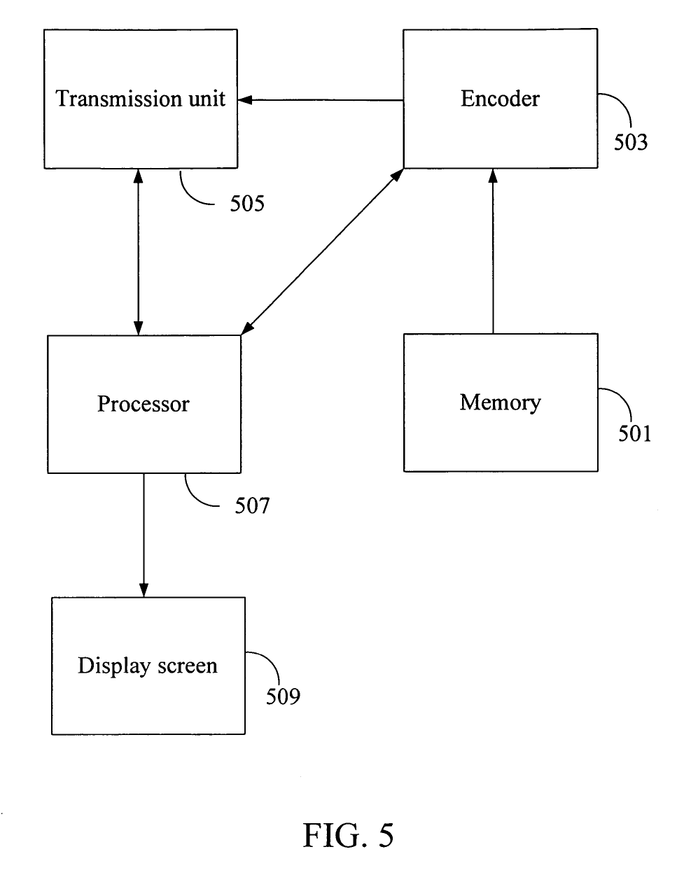

A second embodiment of the present invention is a mobile unit for transmitting contact information as FIG. 5 shows. More particularly, the second embodiment is a mobile phone which comprises a memory 501, an encoder 503, a transmission unit 505, a processor 507, and a display screen 509. The functions of the memory 501, the encoder 503, the transmission unit 505, the processor 507, and the display screen 509 are similar to those of the corresponding elements recited in the first embodiment. The second embodiment may execute all of the steps recited in the first embodiment.

A third embodiment of the present invention is a method for receiving contact information. The third embodiment for receiving the contact information, corresponding to the first embodiment for transmitting the contact information, is applied to a mobile unit, such as a mobile phone, which comprises a receiving unit, a processor, a decoder, a display screen and a memory.

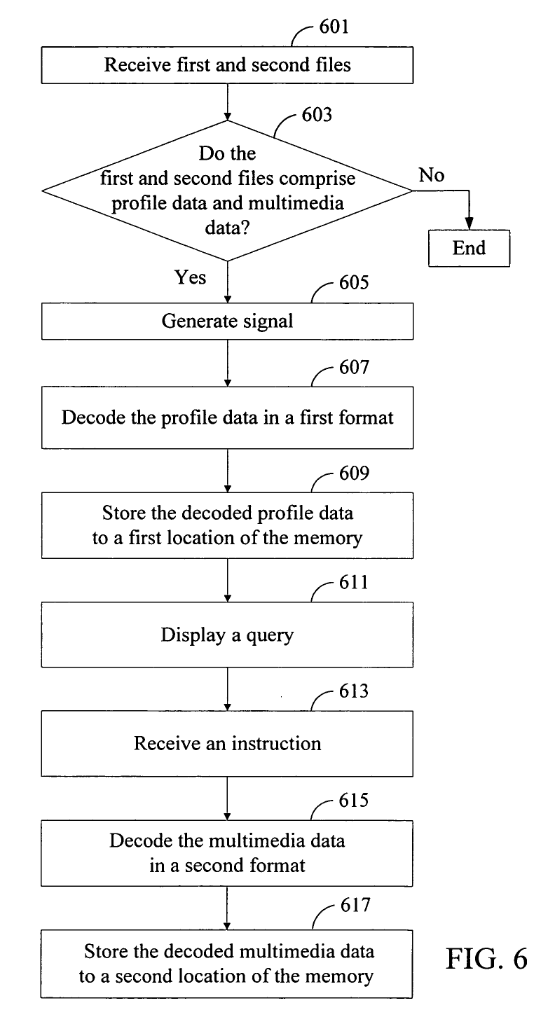

The steps of the third embodiment are shown in FIG. 6. In step 601, the receiving unit receives a first file and a second file. Then step 603 is executed in which the processor determines whether the first file and the second file comprise profile data and multimedia data of contact information, respectively. If yes, step 605 is executed in which the processor generates a signal to indicate receiving the profile data and the multimedia data. Here, the processor may automatically receive all data, including the profile data and the multimedia data, or allow users to choose which data to receive. Users may choose not to receive either the profile data or the multimedia data. In some embodiments, the processor may be set to disable the operation of receiving the multimedia data and receive the profile data only, due to lack of memory space. In step 607, the decoder decodes the profile data in a first format in response to the signal. Then step 609 is executed in which the decoded profile data is stored to a first location of the memory based on the first format. Because the first format is VCF in this case, the first location may be in an area that is defined particularly for storing VCF files.

In the third embodiment, users may decode the multimedia data automatically or manually. When the processor finds that there is at least one multimedia datum associated with the contact information in step 603, the display screen displays a query. The query includes, for example, an option of decoding all of the multimedia data automatically, an option of decoding each of the multimedia data manually, and an option of no decoding for all of the multimedia data. In step 611, the display screen displays the query. In step 613, the processor receives an instruction indicating the decision made by the user. Then step 615 is executed in which the decoder decodes the multimedia data in a second format in response to the signal. Then step 617 is executed in which the decoded multimedia data is stored to a second location of the memory based on the second format so that the processor might realize the connection of the multimedia data and the contact information. The second format may be GIF, CGM, WMF, BMP, MET, PMB, DIB, PICT, TIFF, PS, PDF, JPEG, MPEG, MPEG2, AVI, QTIME, WAVE, PCM, AIFF, 3GP, JPG, WMA, or MP3 format. Similarly, the sequence of steps 601, 603, . . . , 617 is not intended to be a limitation of the present invention.

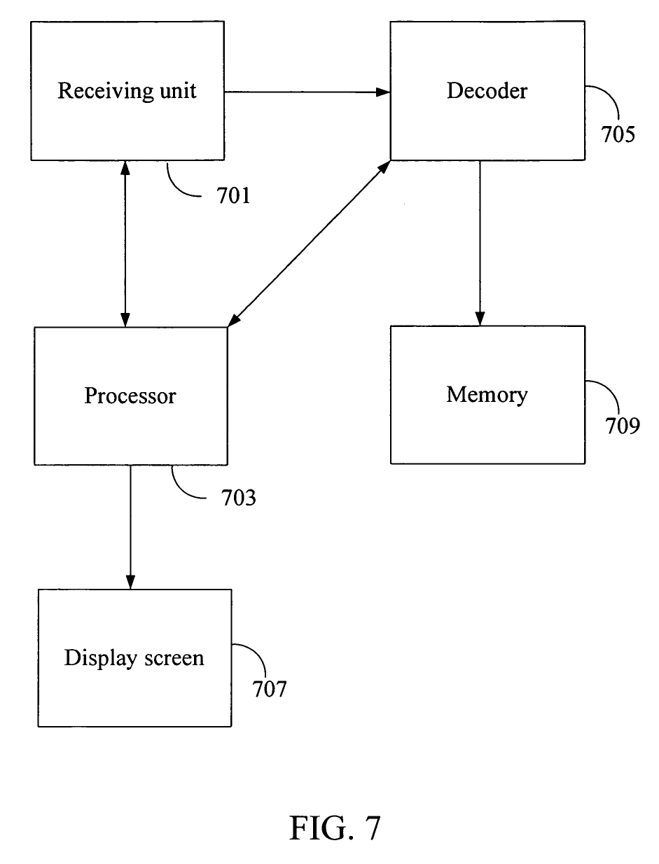

A fourth embodiment of the present invention is a mobile unit for receiving contact information as FIG. 7 shows. More particularly, the fourth embodiment is a mobile phone which comprises a receiving unit 701, a processor 703, a decoder 705, a display screen 707 and a memory 709. The functions of the receiving unit 701, the processor 703, the decoder 705, the display screen 707 and the memory 709 are similar to those of the corresponding elements recited in the third embodiment. That is, the fourth embodiment may execute all of the steps recited in the third embodiment.

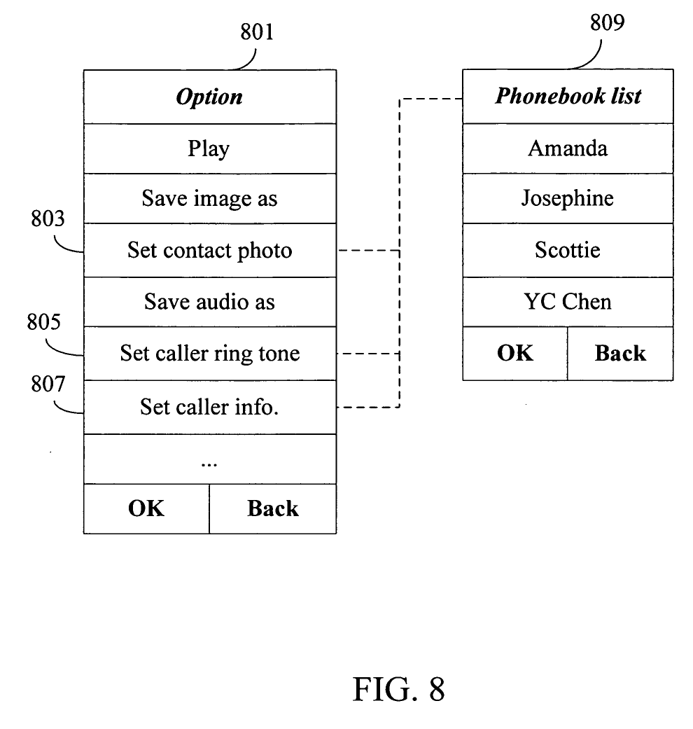

FIG. 8 shows an option menu of the receiving mobile unit. The option menu includes a first option menu 801 having an item 803 of setting contact photo, an item 805 of setting caller ring tone, and an item 807 of setting caller info. The user may select one of the items 803, 805 and 807 to link each of the multimedia data to one field of the contact information. Once the user selects, for example, the item 803, a second option menu 809 is presented where users can further select which profile data to link. If the user selects, for example, Amanda, the multimedia datum is linked to the contact photo field of Amanda's contact information. From now on, the picture carried by the multimedia datum will display on the display screen 707 when Amanda calls. The user may know who calls immediately. Alternatively, the user may select the item 807 in the first option menu 801 to save all of the multimedia data in a particular memory area for one of the persons listed in the second option menu 809. The user may retrieve these data afterwards for other purposes.

The present invention has at least the following advantages:

1. Unrestricted file format: Comparing to the conventional way of sending contact information where, for compatibility, only files with standard formats supported by both mobile phones can be encoded and correctly decoded, the present invention however can be used to encode and decode contact information having multimedia files with any formats without worrying about the compatibility issue.

2. Efficient transmission data size: The conventional solution encodes all data in contact information together for transmission. Sometimes, the size of contact information may be so large that it is banned by the communication network for exceeding size limit. The present invention however transmits each multimedia files in contact information separately as attachments and links them together in the receiving end. Therefore, those files would be transmitted efficiently in light of the channel capacity, and users don't need to worry about the size of the multimedia files.

3. Easy development: The present invention only requires the capability of distinguishing the attributes of the profile data and the multimedia data associated with contact information. In contrast with writing code to define the multimedia data in the explanatory types, the development of the present invention is much more straightforward. Besides, the encoder and decoder of the invention do not have to be specially designed.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for transmitting contact information, the contact information comprising a profile datum and a multimedia datum, the method comprising:
encoding the profile datum in a first format into a first file;
encoding the multimedia datum in a second format into a second file; and
transmitting both the first file and the second file.

2. The method as claimed in claim 1, further comprising the step of:
selecting a transmission service for transmitting the first and the second files.

3. The method as claimed in claim 2, wherein the transmission service is one of multimedia messaging service (MMS), electronic mail (e-mail), infrared data association (IrDA), and Bluetooth.

4. The method as claimed in claim 1, wherein the multimedia datum comprises one of a video datum, an image datum, and an audio datum.

5. The method as claimed in claim 1, wherein the multimedia datum comprises one of a caller video, a caller picture, and a caller ring tone.

6. The method as claimed in claim 1, wherein the first format is a VCF format.

7. The method as claimed in claim 1, wherein the second format is one of GIF, CGM, WMF, BMP, MET, PMB, DIB, PICT, TIFF, PS, PDF, JPEG, MPEG, MPEG2, AVI, QTIME, WAVE, PCM, AIFF, 3GP, JPG, WMA, and MP3 format.

8. A mobile unit for transmitting contact information, the contact information comprising a profile datum and a multimedia datum, the mobile unit comprising:
a memory for storing the profile datum and the multimedia datum;
an encoder for retrieving the profile datum and the multimedia datum from the memory, for encoding the profile datum in a first format into a first file, and for encoding the multimedia datum in a second format into a second file; and
a transmission unit for transmitting both of the first file and the second file.

9. The mobile unit as claimed in claim 8, wherein the transmission unit transmits the first and the second files through a transmission service.

10. The mobile unit as claimed in claim 9, wherein the transmission service is one of MMS, e-mail, IrDA, and Bluetooth.

11. The mobile unit as claimed in claim 8, wherein the multimedia datum comprises one of a video datum, an image datum, and an audio datum.

12. The mobile unit as claimed in claim 8, wherein the multimedia datum comprises one of a caller video, a caller picture, and a caller ring tone.

13. The mobile unit as claimed in claim 8, wherein the first format is a VCF format.

14. The mobile unit as claimed in claim 8, wherein the second format is one of GIF, CGM, WMF, BMP, MET, PMB, DIB, PICT, TIFF, PS, PDF, JPEG, MPEG, MPEG2, AVI, QTIME, WAVE, PCM, AIFF, 3GP, JPG, WMA, and MP3 format.

15. A method for receiving contact information, the contact information comprising a profile datum and a multimedia datum, the method comprising:
receiving a first file and a second file;
determining whether the first file and the second file comprise the profile datum and the multimedia datum, if yes, executing the following steps;
decoding the profile datum in a first format;
storing the decoded profile datum to a first location based on the first format;
decoding the multimedia datum in a second format; and
storing the decoded multimedia datum to a second location based on the second format.

16. The method as claimed in claim 15, further comprising the steps of:
displaying a query of decoding the multimedia datum automatically or manually; and
receiving an instruction responsive to the query;
wherein the step of decoding the multimedia datum is executed automatically or manually in response to the instruction.

17. A mobile unit for receiving contact information, the contact information comprising a profile datum and a multimedia datum, the mobile unit comprising:
a receiving unit for receiving a first file and a second file;
a processor for determining whether the first file and the second file comprise the profile datum and the multimedia datum, and if yes, generating a signal or invoke the specific function;
a decoder for decoding the profile datum in a first format and for decoding the multimedia datum in a second format in response to the signal; and
a memory for storing the decoded profile datum in a first location based on the first format and storing the decoded multimedia datum in a second location based on the second format.

18. The mobile unit as claimed in claim 17, further comprising a display screen for displaying a query of decoding the multimedia datum automatically or manually, wherein the decoder decodes the multimedia datum automatically or manually in response to an instruction responsive to the query.
